(19) United States
(12) Patent Application Publication
(10) Pub. No.: US 2008/0166633 A1
(43) Pub. Date: Jul. 10, 2008

(54) ANODE FOR LITHIUM BATTERY AND LITHIUM BATTERY EMPLOYING THE SAME

(76) Inventors: Seung-sik Hwang, Seongnam-si (KR); Seok-gwang Doo, Seoul (KR)

Correspondence Address: CHRISTIE, PARKER & HALE, LLP, PO BOX 7068, PASADENA, CA, 91109-7068, US

(21) Appl. No.: 11/830,763

(22) Filed: Jul. 30, 2007

(30) Foreign Application Priority Data
Jan. 5, 2007 (KR) 10-2007-0001665

(51) Int. Cl. H01M 4/62

(52) U.S. Cl. 429/217

(57) ABSTRACT

Anodes for lithium batteries and lithium batteries employing the anodes are provided. In one embodiment, an anode includes an anode active material, and a binder including a waterborne acrylic polymer and a water-soluble polymer. The binder permeates the anode active materials to provide binding force between the anode active materials through point binding. The binder has excellent binding force and elasticity, and does not experience the spring-back phenomenon during electrode manufacture. The anodes have improved assembly density, high capacity and high energy density. Further, the anodes have improved lifetime characteristics since the anode structure is maintained long term over repeated charge/discharge cycles.

### CROSS-REFERENCE TO RELATED PATENT APPLICATION

This application claims priority to and the benefit of Korean Patent Application No. 10-2007-0001665, filed on Jan. 5, 2007 in the Korean Intellectual Property Office, the entire content of which is incorporated herein by reference.

### BACKGROUND OF THE INVENTION

1. Field of the Invention

The present invention relates to anodes for lithium batteries and lithium batteries employing the same.

2. Description of the Related Art

Lithium batteries have high voltages and high energy densities, and have enhanced stability compared with other batteries, such as Ni—Cd batteries. Due to these advantages, lithium batteries are used as power sources for portable electric applications. However, developments in the small and lightweight display industry require smaller, lightweight portable electric applications to have high capacity, thereby necessitating the development of batteries having higher operating voltages, longer lifetimes, and higher energy densities than conventional lithium batteries. Batteries having these properties can be developed by improving the performance of various battery components.

Generally, battery properties are dependent on the electrodes, electrolytes, and other battery materials included therein. Particularly, electrode properties are dependent on electrode active materials, current collectors, and binders that provide binding force between electrode active materials and between the electrode active materials and current collectors.

The binder provides binding force between electrode active materials, between the electrode active materials and a conducting agent, or among the electrode active materials, the conducting agent and the metal current collector. When a binder provides strong binding force between active materials or between an active material and a current collector, electrons and lithium ions move smoothly within the electrode and the inner resistance of the electrode decreases. As a result, relatively high rate charge/discharge can be realized. In addition, the binder buffers volume changes in the lithium battery generated during charge/discharge. High capacity batteries require composite electrodes including carbon and graphite, or carbon and silicon as anode active materials, in which case, the active material of the composite electrode expands and contracts to a large extent during charging and discharging. Accordingly, in addition to excellent binding force, the binder must have excellent elastic and recovery properties such that the original binding force of the binder and the electrode structure can be maintained even after expanding and contracting. The binder needs to have a constant slurry viscosity during electrode manufacture to provide stability to the slurry, thus enabling smooth coating of the slurry.

Polyvinylidene fluoride (PVDF) based polymers are used as conventional binder materials and are dissolved in an organic solvent such as N-methyl-2-pyrrolidone when used. While PVDF based polymers have strong binding forces, PVDF based polymers cannot effectively buffer the volume changes of the electrode due to their very weak elasticity. Meanwhile, such binders bind electrode active materials through surface binding mechanisms, as illustrated in FIG. 1.

Styrene-butadiene rubbers (SBRs) are also used as binder materials. Although SBRs have excellent elasticity, their weak binding force causes the electrode structure to change upon repeated charge/discharge. Further, SBRs have high crosslinking density and recovery power, causing a spring-back phenomenon in which the thickness of the electrode after rolling returns to the original thickness, as illustrated in FIG. 3.

High capacity metal/graphite composite anodes have reduced lifetimes since the metal active materials and the structure of the electrodes are damaged by excessive volume expansion and contraction during repeated charge/discharge cycles.

### SUMMARY OF THE INVENTION

In one embodiment of the present invention, an anode for a lithium battery having increased assembly density and electrode energy density is achieved by providing excellent binding force and elasticity. The battery also has improved lifetime characteristics by maintaining the electrode structure.

According to another embodiment of the present invention, a lithium battery employs the anode.

According to one embodiment of the present invention, an anode for a lithium battery includes an anode active material, and a binder including a waterborne acrylic polymer and a water-soluble polymer, wherein the binder permeates the anode active material to provide a binding force between the anode active materials via point binding.

According to another embodiment of the present invention, a lithium battery includes a cathode, an anode, and a separator interposed between the cathode and the anode.

The binder used in the lithium battery may be an environmentally friendly material having strong binding force. Such a binder is achieved by dispersing the waterborne acrylic polymer and water-soluble polymer in water. The electrode using the binder can have high capacity, high energy density, and improved lifetime characteristics due to improved assembly density.

### BRIEF DESCRIPTION OF THE DRAWINGS

The above and other features and advantages of the present invention will become more apparent by reference to the following detailed description when considered in conjunction with the attached drawings in which:

FIG. 1 is a schematic view of a prior art surface binding mechanism for binding active materials in an anode for a lithium battery using a polyvinylidene fluoride (PVDF) binder;

FIG. 2 is a schematic view of a point binding mechanism for binding active materials in an anode for a lithium battery according to one embodiment of the present invention;

FIG. 3 is a schematic illustrating a spring-back phenomenon occurring during rolling of an anode for a lithium battery using a prior art styrene-butadiene rubber (SBR) binder;

FIG. 4 is a schematic illustrating the thickness of an anode for a lithium battery before and after rolling of the anode according to one embodiment of the present invention;

FIG. 5 is a flow chart illustrating a process of manufacturing an anode for a lithium battery according to one embodiment of the present invention;

FIG. 6 is a graph comparing the discharge capacities with respect to the number of charge/discharge cycles of electrodes prepared according to Example 1 and Comparative Examples 1 and 2;

FIG. 7 is a graph comparing energy per volume with respect to the number of charge/discharge cycles of the lithium batteries prepared according to Example 2 and Comparative Example 3; and

FIG. 8 is schematic cross-sectional view of a lithium battery according to one embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as limited to the embodiments set forth herein. Rather, these embodiments are provided for illustrative purposes only.

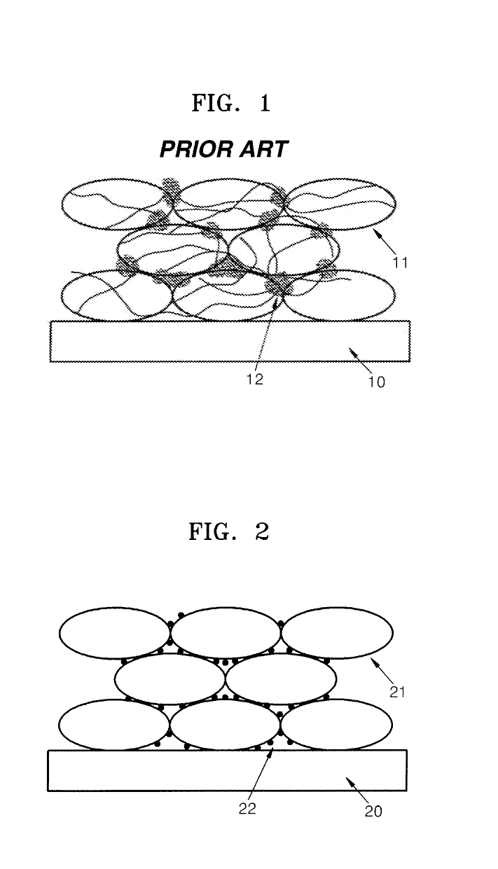

FIG. 2 is a schematic view of a point binding mechanism for binding active materials in an anode for a lithium battery according to one embodiment of the present invention. Referring to FIG. 2, anode active materials 21 are formed on a substrate 20, and binders 22 are filled in openings between the anode active materials 21. The binders 21 filled in the openings between the anode active materials bind the anode active materials 21 through a point binding mechanism. When a surface binding mechanism (as illustrated in FIG. 1) is used, a large amount of binder is required to bind the anode active materials. However, when a point binding mechanism is used (as illustrated in FIG. 2), only a small amount of binder is needed to manufacture an electrode having excellent assembly density.

As used herein, a “point binding mechanism” indicates that fine particles of the binder adhere to the anode active materials to bind the active materials rather than surrounding the surface of the anode active materials.

A waterborne acrylic polymer may be used as a binder for the anode for a lithium battery according to the present invention. Waterborne acrylic polymers have excellent elasticity, and thus may buffer volume changes in the lithium battery during charge/discharge cycles. Further, since waterborne acrylic polymers have excellent adhering force, active materials are not separated from current collectors, and thus the structure of the electrodes can be maintained for long term use.

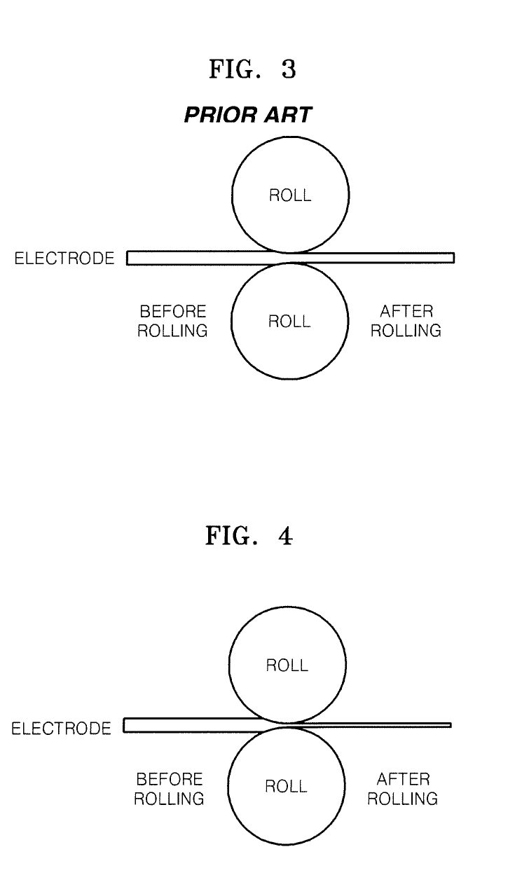

FIG. 4 is a schematic illustrating the thickness of an anode for a lithium battery before and after rolling of the anode according to one embodiment of the present invention. The electrode using the waterborne acrylic polymer is thin in thickness and has high assembly density after rolling because the spring-back phenomenon does not occur, in contrast to the electrode using styrene-butadiene rubber (SBR) as a binder (illustrated in FIG. 3).

Nonlimiting examples of suitable waterborne acrylic polymers for use in the anode for a lithium battery according to one embodiment of the present invention include polyethylacrylate, polyethylmethacrylate, polypropylacrylate, polypropylmethacrylate, polyisopropylacrylate, polyisopropylmethacrylate, polybutylacrylate, polybutylmethacrylate, polyhexylacrylate, polyhexylmethacrylate, polyethylhexylacrylate, polyethylhexylmethacrylate, polylaurylacrylate, polylaurylmethacrylate and combinations thereof, considering binding force and elasticity.

The waterborne acrylic polymer as a binder for the lithium battery according to one embodiment of the present invention may be prepared by emulsifying a acrylic monomer such as ethylacrylate with water and polymerizing the acrylic monomer. In addition, particles of the acrylic polymer dispersed in water can bind the active materials through a point binding mechanism during active material formation. Further, the acrylic polymer is an environmentally friendly polymer since an organic solvent is not required during the electrode manufacturing process.

The average particle diameter of the waterborne acrylic polymer is adjusted to a diameter appropriate for point binding in the anode for the lithium battery. Particularly, the particle diameter of the waterborne acrylic polymer may range from about 0.1 to about 5% based on the average particle diameter of the anode active materials. For example, when the average particle diameter of the anode active materials ranges from about 10 to about 30 μm, the average particle diameter of the waterborne acrylic polymer may range from about 0.1 to about 1 μm. When the average particle diameter of the waterborne acrylic polymer is less than about 0.1 μm, the binding force between the active materials may not be sufficient. When the average particle diameter of the waterborne acrylic polymer is greater than about 1 μm, the binding force may also not be sufficient since the number of binder particles in the same amount of binder may be reduced, making it difficult for the binder to perform the point binding mechanism.

A water-soluble polymer may be included as a thickener in the binder for the lithium battery according to one embodiment of the present invention. The water-soluble polymer facilitates coating of a slurry including the anode active materials on the current collector, and increases dispersion of the slurry including the anode active materials and waterborne acrylic polymer. The anode for a lithium battery according to one embodiment of the present invention may have excellent binding force since the waterborne acrylic polymer binds active materials and the water-soluble polymer facilitates binding between active materials and between the current collector and the active materials.

Nonlimiting examples of suitable water-soluble polymers include sodium carboxymethyl cellulose, methyl cellulose, hydroxy methyl cellulose, hydroxy propyl cellulose, ethyl cellulose, polyvinyl alcohol, polyvinylpyrrolidone, polyethylene oxide, oxidized starch, phosphorylated starch, casein, and mixtures thereof.

1 wt % of the water-soluble polymer may have a viscosity ranging from about 100 to about 2,000 mPa·s at 25° C. When the viscosity of the water-soluble polymer is less than about 100 mPa·s, the dispersibility of the slurry including the anode active materials may be reduced. On the other hand, when the viscosity of the water-soluble polymer is greater than about 2,000 mPa·s, smooth coating is difficult to achieve.

In one embodiment of the anode for a lithium battery, the amount of the binder including the waterborne acrylic polymer and the water-soluble polymer may range from about 1 to about 15 parts by weight based on 100 parts by weight of the anode active material. For example, the binder may be present in an amount ranging from about 2 to about 6 parts by weight based on 100 parts by weight of the anode active material. When the amount of the binder is less than about 1 part by weight, the binding force of the binder may be too weak. Further, when the amount of the binder is greater than about 15 parts by weight, energy density may be reduced without improving binding efficiency.

In one embodiment of the anode for a lithium battery, the weight ratio of the waterborne acrylic polymer to the water-soluble polymer in the binder ranges from about 1:10 to about 10:1. When the weight ratio is less than about 1:10, the binding force between the anode active materials may be reduced, and thus the structure of the anode may not be maintained long term over repeated charge/discharge cycles. On the other hand, when the weight ratio is greater than about 10:1, energy density may be reduced without improving the binding force between the anode active materials.

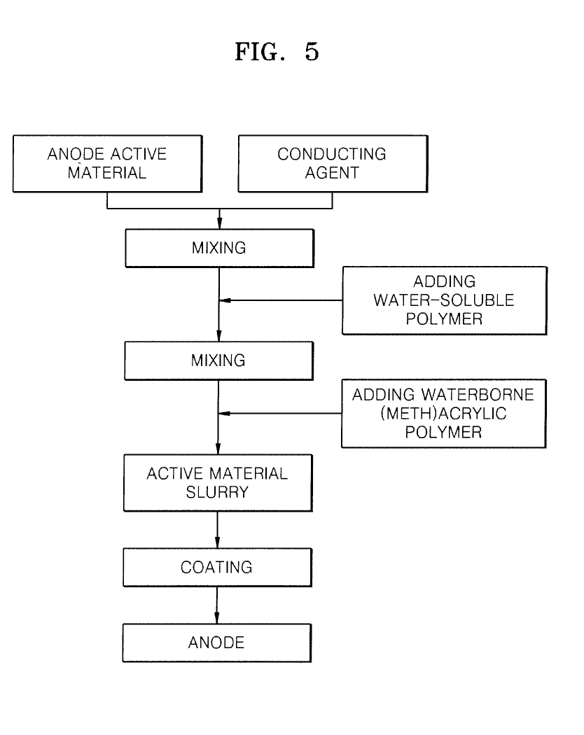

FIG. 5 is a flow chart illustrating a process of manufacturing an anode for a lithium battery according to one embodiment of the present invention. Referring to FIG. 5, first, an anode active material is mixed with a conducting agent. A water-soluble polymer and a waterborne acrylic polymer are sequentially added thereto to prepare an active material slurry. An anode plate is then prepared by coating the slurry directly on a current collector. Alternatively, the anode plate is prepared by casting the slurry on a separate support to form a film which is separated from the support and laminated on a copper current collector. The anode mixture material including the binder may be molded into a shape, or the anode mixture material may be coated on a current collector such as a copper foil. The prepared anode is passed through a roller to prepare an anode plate.

The anode active material may be a graphite material such as natural graphite, artificial graphite, coke, or carbon fiber. Alternatively, the anode active material may be an element that can be alloyed with Li, such as Al, Si, Sn, Ag, Bi, Mg, Zn, In, Ge, Pb, or Ti, a compound or complex containing the element capable of alloying with Li, or a compound containing the element capable of alloying with Li, carbon, or a graphite material. The anode active material may alternatively be a N-based compound containing Li.

A battery requires the charging/discharging of a large current to ensure high capacity. For this, a battery electrode should have low electric resistance. Thus, various conducting agents are generally added to reduce the resistance of the electrode. However, in the anodes according to the present invention, conducting agents need not be added, since the anode has excellent conductivity without the additives. The conducting agent may be added to the anode active material when low conducting agent materials, such as carbon/silicon active materials, are used as the anode active materials. Nonlimiting examples of suitable conducting agents include carbon black, graphite microparticles, etc.

Any current collector that is electrically conductive without causing chemical changes in the battery may be used as the current collector for the waterborne lithium battery. Nonlimiting examples of suitable current collectors include stainless steel, nickel, copper, titan, carbon, copper, and materials in which carbon, nickel, titan or silver is attached on the surface of stainless steel. In one embodiment, copper or a copper alloy is used as the current collector.

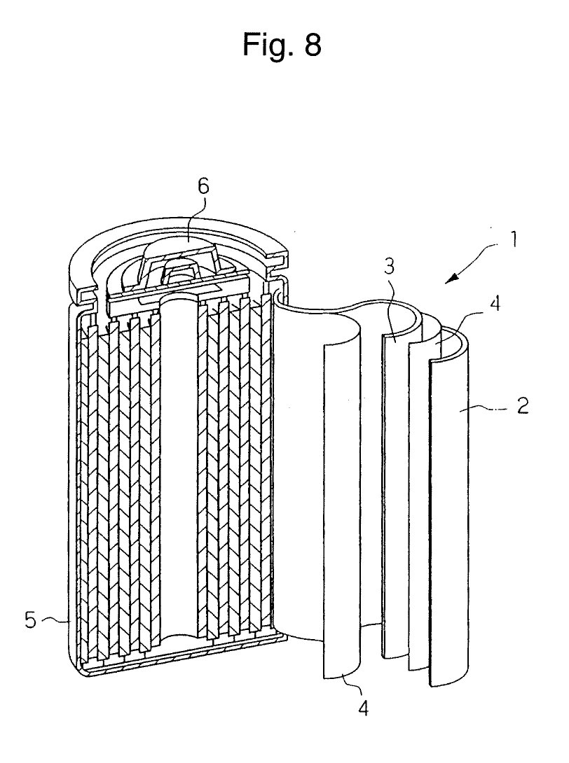

According to another embodiment of the present invention, a lithium battery includes the anode. A lithium battery according to one embodiment is illustrated in FIG. 8.

First, a cathode can be manufactured as follows. A cathode active material, a conducting agent, a binder resin, and a solvent are mixed to prepare a cathode active material composition. The cathode active material composition is directly coated on a metal current collector and dried to prepare a cathode plate. Alternatively, the cathode active material composition is cast on a separate support and dried to form a film which is then separated from the support and laminated on a metal current collector to prepare a cathode plate.

The cathode active material may be a Li-containing metal oxide commonly used in the art. Nonlimiting examples of suitable cathode active materials include LiCoO₂, LiMnₓO₂ₓ, LiNi₁₋ₓMnₓO₂ₓ (where x=1, 2), Ni_{1-x-y}CoₓMn_{y}O₂ (where 0≦x≦0.5, 0≦y≦0.5), and compounds in which Li is oxidized and reduced such as LiMn₂O₄, LiCoO₂, LiNiO₂, LiFeO₂, V₂O₅, TiS and MoS.

In the cathode, the conducting agent may be carbon black, the binder may be polyvinylidene fluoride (PVDF), and the solvent may be NMP, or the like. The amounts of the conducting agent, the binder and the solvent are those commonly used in lithium batteries.

As shown in FIG. 8, a lithium battery 1 according to one embodiment of the present invention may include a cathode 2 and an anode 3. The lithium battery may also include a polymer electrolyte layer (or separator) 4 including a polymer electrolyte composition as a separator composition. The polymer electrolyte may be those commonly used in lithium batteries.

The separator may include any material that is commonly used in lithium batteries. For example, the separator may include a material having a low resistance to the movement of ions of the electrolyte and a good ability to absorb the electrolytic solution. The separator material may be a non-woven or woven fabric selected from glass fibers, polyester, Teflon, polyethylene, polypropylene, polytetrafluoroethylene (PTFE) and combinations thereof.

Nonlimiting examples of suitable solvents include propylene carbonate, ethylene carbonate, diethyl carbonate, ethyl methyl carbonate, methyl propyl carbonate, butylene carbonate, benzonitrile, acetonitrile, tetrahydrofuran, 2-methyl tetrahydrofuran, γ-butyrolactone, dioxolane, 4-methyl dioxolane, N,N-dimethylformamide, dimethyl acetamide, dimethylsulfoxide, dioxane, 1,2-dimethoxyethane, sulfolane, dichloroethane, chlorobenzene, nitrobenzene, dimethylcarbonate, methylethylcarbonate, diethylcarbonate, methylpropylcarbonate, methylisopropylcarbonate, ethylpropylcarbonate, dipropylcarbonate, dibutylcarbonate, diethyleneglycol, dimethyl ether, mixtures thereof, etc. Nonlimiting examples of suitable electrolytes include lithium salts such as LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ₊₁SO2)(C_{y}F_{2y+1}SO₂) (wherein x and y are natural numbers), LiCl, Lil, and the like.

The separator 4 is positioned between the cathode plate 2 and the anode plate 3 to form a battery assembly. The battery assembly is wound or folded and placed in a cylindrical or rectangular battery case 5 and sealed with a cap plate 6. Then, the electrolytic solution is injected into the battery case to complete the lithium ion battery.

Alternatively, the battery assembly may be laminated to form a bi-cell structure and impregnated with an organic electrolyte solution. The resultant structure is encased in a pouch and sealed to complete a lithium ion polymer battery.

Since the anode for a lithium battery according to an embodiment of the present invention is prepared by mixing a waterborne acrylic polymer and a water-soluble polymer, an organic solvent is not required during the anode manufacturing process. An electrode plate having high assembly density can be prepared without experiencing the spring-back phenomenon that usually occurs during rolling of the electrode. Further, the structure of the electrode can be maintained long term over repeated charge/discharge cycles.

Hereinafter, the present invention will be described with reference to the following examples. The following examples are presented for illustrative purposes only, and are not intended to limit the scope of the invention.

### EXAMPLES

### Preparation of Anode

### Example 1

77 g of an anode active material (a complex active material including graphite obtained from Osaka Gas Chemical Co., silicon metal and carbon) having a particle diameter of 20 μm was mixed with 20 g of a conducting agent (graphite conducting agent obtained from Timcal Co., SFG6). 150 g of 1 wt % sodium carboxymethyl cellulose solution was added thereto and mixed to form a solution. 3.75 g of 40 wt % polyethylhexylacrylate having a particle diameter of 0.25 μm dispersed in water and water was added to the solution and mixed to prepare a slurry having 200 g of water.

The prepared slurry was coated on a copper (Cu) current collector to a thickness of about 80 μm using a doctor blade. The coated collector was dried in a hot air dryer, and then dried in a vacuum at 120° C. again to prepare an anode. The anode was rolled using a roller to a thickness of about 50 μm to prepare an anode plate.

### Example 2

An anode plate was prepared as in Example 1, except that 100 g of 1 wt % sodium carboxymethyl cellulose solution and 5 g of 40 wt % polyethylhexylacrylate dispersed in water were used.

### Comparative Example 1

An anode in which the anode active materials were bonded to each other through a surface binding mechanism was prepared using a binder dissolved in an organic solvent. A binder solution was prepared by dissolving polyvinylidene fluoride in NMP to a concentration of 5 wt %. 74.62 g of the anode active material prepared in Example 1 was mixed with 19.38 g of a conducting agent, and 120 g of the binder solution was added thereto to prepare a slurry. The slurry was coated on a current collector, dried and rolled as in Example 1 to prepare an anode plate.

### Comparative Example 2

An anode plate was prepared as in Example 1, except that styrene-butadiene rubber (SBR) was used instead of polyethylhexylacrylate.

### Comparative Example 3

An anode plate was prepared as in Example 2, except that styrene-butadiene rubber (SBR) was used instead of polyethylhexylacrylate.

The assembly densities of the anode plates prepared according to Examples 1 and 2 and Comparative Examples 1 through 3 are shown in Table 1 below.

TABLE 1

| Anode | Assembly density (g/cc) |
|---|---|
| Example 1 | 1.56 |
| Example 2 | 1.62 |
| Comparative Example 1 | 1.50 |
| Comparative Example 2 | 1.45 |
| Comparative Example 3 | 1.50 |

### Preparation of Lithium Battery

Unit cells were manufactured using the anode plates prepared according to Examples 1 and 2 and Comparative Examples 1 through 3, a cathode having an average capacity of 14.82 mAh as an opposite electrode, a PE separator, and a solution of 1.3 M LiPF6 in a 3:7 mixed solvent of ethylene carbonate (EC) and diethyl carbonate (DEC) as an electrolyte solution.

### Charge/Discharge Experiments

### 1^{st} Charge/Discharge Cycle

Each of the prepared batteries were subjected to constant-current charging under a constant charging current of 2.964 mA until the voltage reached 4.2 V. Then, constant-voltage charging was performed under a constant charging voltage of 4.2 V until the current reached 0.148 mA or for 10 hours.

The fully charged lithium batteries were allowed to stand for about 10 minutes. Then, constant-current discharging was performed under a constant discharging current of 2.964 mA until the voltage reached 2.75 V.

### 2^{nd} Charge/Discharge Cycle

After the first charge/discharge cycle, each battery was subjected to constant-current charging under a constant charging current of 7.41 mA until the voltage reached 4.2 V. Then, constant-voltage charging was performed under a constant charging voltage of 4.2 V until the current reached 0.148 mA or for 10 hours.

The fully charged lithium batteries were allowed to stand for about 10 minutes. Then, constant-current discharging was performed under a constant discharging current of 2.964 mA until the voltage reached 2.75 V.

### 3^{rd} Charge/Discharge Cycle

After the second charge/discharge cycle, each of the batteries was subjected to constant-current charging under a constant charging current of 7.41 mA until the voltage reached 4.2 V. Then, constant-voltage charging was performed under a constant charging voltage of 4.2 V until the current reached 0.148 mA or for 10 hours.

The fully charged lithium batteries were allowed to stand for about 10 minutes. Then, constant-current discharging was performed under a constant discharging current of 7.41 mA until the voltage reached 2.75 V.

### 4^{th} Charge/Discharge Cycle

After the third charge/discharge cycle, each battery was subjected to constant-current charging under a constant charging current of 14.82 mA until the voltage reached 4.2 V. Then, constant-voltage charging was performed under a constant charging voltage of 4.2 V until the current reached 0.148 mA or for 10 hours.

The fully charged lithium batteries were allowed to stand for about 10 minutes. Then, constant-current discharging was performed under a constant discharging current of 14.82 mA until the voltage reached 2.75 V.

### 5^{th} to 54^{th} Charge/Discharge Cycles

For each of the 5^{th} through 54^{th} charge/discharge cycles, each battery was subjected to constant-current charging under a constant charging current of 7.41 mA until the voltage reached 4.2 V. Then, constant-voltage charging was performed under a constant charging voltage of 4.2 V until the current reached 0.741 mA or for 10 hours.

The fully charged lithium batteries were allowed to stand for about 10 minutes. Then, constant-current discharging was performed under a constant discharging current of 7.41 mA until the voltage reached 2.75 V.

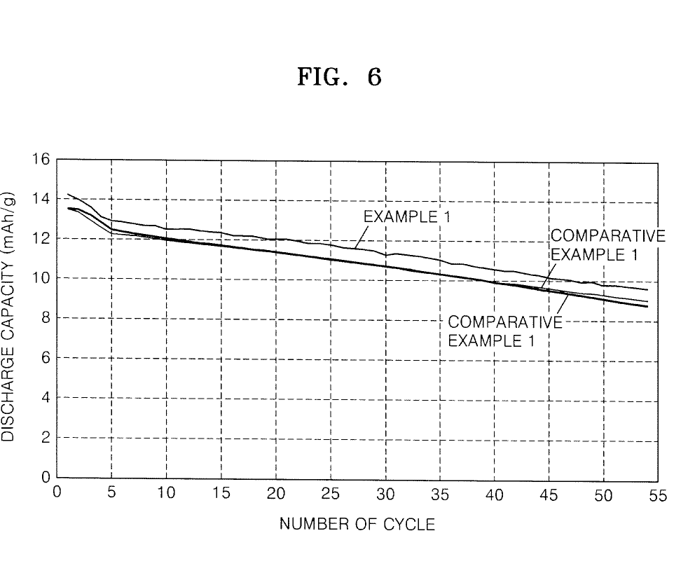

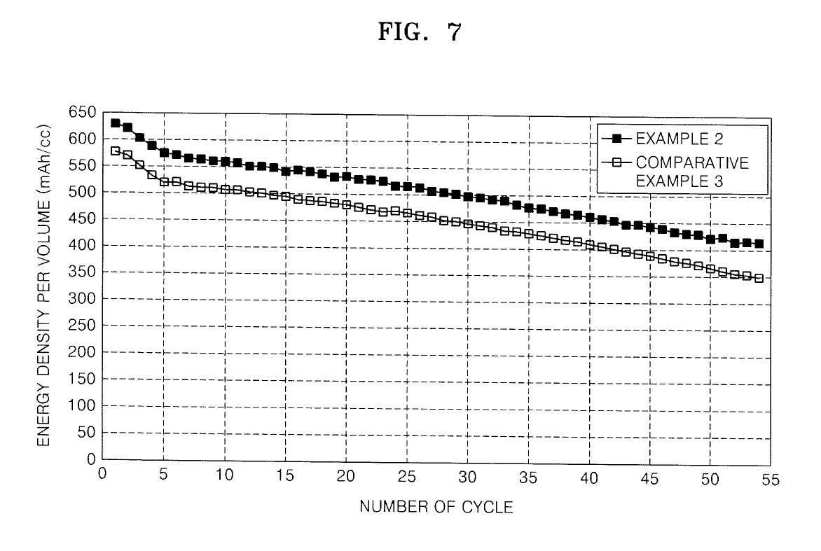

Lifetime of the lithium batteries prepared according to Example 1 and Comparative Examples 1 and 2 were compared by measuring discharge capacity with respect to the number of charge/discharge cycles, and the results are shown in FIG. 6. Further, energy density per volume of the lithium batteries prepared according to Example 2 and Comparative Example 3 with respect to the number of charge/discharge cycles was also measured, and the results are shown in FIG. 7.

As shown in Table 1, the anodes for lithium batteries according to embodiments of the present invention have improved assembly densities compared to the anodes prepared using polyvinylidene fluoride or styrene-butadiene rubber (SBR) as the binder.

As illustrated in FIG. 6, the lithium batteries according to embodiments of the present invention have larger discharge capacities compared to the anodes prepared using polyvinylidene fluoride or styrene-butadiene rubber (SBR) as the binder.

As illustrated in FIG. 7, the anode prepared using the binder according to Example 2 of the present invention has improved energy density compared to the anode prepared using styrene-butadiene rubber (SBR) as the binder according to Comparative Example 3. In addition the anode prepared according to Example 2 maintains the improved energy density over the increasing number of charge/discharge cycles. Thus, the binders according to embodiments of the present invention strengthen the binding force between anode active materials, thus increasing the assembly densities of the anodes and improving the lifetime characteristics of the anodes by maintaining the structure over long term use.

The anodes for lithium batteries according to the present invention bind the anode active materials through a point binding mechanism, enabling preparation of electrodes having high assembly density without experiencing the spring-back phenomenon during electrode manufacture. Accordingly, lithium batteries having high capacities and high energy densities can be manufactured using the anodes. Further, the lithium batteries can have long lifetimes since the electrode structures can be maintained over long term use.

While the present invention has been illustrated and described with reference to certain exemplary embodiments, it will be understood by those of ordinary skill in the art that various changes and modifications may be made to the described embodiments without departing from the spirit and scope of the present invention as defined by the following claims.

What is claimed is:

1. An anode for a lithium battery comprising:
an anode active material; and
a binder comprising a waterborne acrylic polymer and a water-soluble polymer, wherein the binder is bonded to the anode active material by point binding.

2. The anode of claim 1, wherein an average particle diameter of the waterborne acrylic polymer ranges from about 0.1 to about 5% based on an average particle diameter of the anode active material.

3. The anode of claim 1, wherein an average particle diameter of the waterborne acrylic polymer ranges from about 0.1 to about 1 μm.

4. The anode of claim 1, wherein the waterborne acrylic polymer is selected from the group consisting of polyethylacrylate, polyethylmethacrylate, polypropylacrylate, polypropylmethacrylate, polyisopropylacrylate, polyisopropylmethacrylate, polybutylacrylate, polybutylmethacrylate, polyhexylacrylate, polyhexylmethacrylate, polyethylhexylacrylate, polyethylhexylmethacrylate, polylaurylacrylate, polylauryl(meth)acrylate and mixtures thereof.

5. The anode of claim 1, wherein the water-soluble polymer is selected from the group consisting of sodium carboxymethyl cellulose, methyl cellulose, hydroxy methyl cellulose, hydroxy propyl cellulose, ethyl cellulose, polyvinyl alcohol, polyvinylpyrrolidone, polyethylene oxide, oxidized starch, phosphorylated starch, casein and mixtures thereof.

6. The anode of claim 1, wherein the water-soluble polymer has a viscosity in a 1 wt % solution ranging from about 100 to about 2,000 mPa·s at 25° C.

7. The anode of claim 1, wherein the binder is present in an amount ranging from about 1 to about 15 parts by weight based on 100 parts by weight of the anode active material.

8. The anode of claim 1, wherein a weight ratio of the waterborne acrylic polymer to the water-soluble polymer ranges from about 0.1 to about 10.

9. A lithium battery comprising:
a cathode,
an anode according to claim 1, and
a separator between the cathode and the anode.

10. The lithium battery of claim 9, wherein an average particle diameter of the waterborne acrylic polymer ranges from about 0.1 to about 5% based on an average particle diameter of the anode active material.

11. The lithium battery of claim 9, wherein an average particle diameter of the waterborne acrylic polymer ranges from about 0.1 to about 1 μm.

12. The lithium battery of claim 9, wherein the water-soluble polymer has a viscosity in a 1 wt % solution ranging from about 100 to about 2,000 mPa·s at 25° C.

13. The lithium battery of claim 9, wherein the binder is present in the anode in an amount ranging from about 1 to about 15 parts by weight based on 100 parts by weight of the anode active material.
